(19) United States
(12) Patent Application Publication
(10) Pub. No.: US 2026/0115830 A1
(43) Pub. Date: Apr. 30, 2026

(54) METHOD FOR REPRODUCING ELECTROCHEMICAL PROPERTIES OF A LITHIUM FOIL

(71) Applicant: TRUMPF LASER- UND SYSTEMTECHNIK SE, Ditzingen (DE)

(72) Inventors: Oliver BOCKSROCKER, Sachsenheim (DE); Günter AMBROSY, Stuttgart (DE)

(21) Appl. No.: 19/426,079

(22) Filed: Dec. 19, 2025

Related U.S. Application Data
(63) Continuation of application No. PCT/EP2024/051944, filed on Jan. 26, 2024.

(30) Foreign Application Priority Data
Jun. 26, 2023 (DE) 10 2023 116 767.7

(51) Int. Cl. B23K 26/0622; B23K 26/06; B23K 26/062; B23K 26/082; B23K 26/352; B23K 26/38; B23K 101/36

(52) U.S. Cl. CPC B23K 26/0624; B23K 26/0604; B23K 26/0626; B23K 26/082; B23K 26/352; B23K 26/38; B23K 2101/36

(57) ABSTRACT

A method for processing a surface of a lithium foil, the method including using a pulsed laser beam source to reduce an ion resistance of the lithium foil. The laser beam source is configured to remove lithium compounds formed on the lithium foil and introduce a structure into the surface of the lithium foil.

### CROSS REFERENCE TO RELATED APPLICATIONS

This application is a continuation of International Application No. PCT/EP2024/051944 (WO 2025/002597 A1), filed on Jan. 26, 2024, and claims benefit to German Patent Application No. DE 10 2023 116 767.7, filed on Jun. 26, 2023. The aforementioned applications are hereby incorporated by reference herein.

### FIELD

The invention relates to a method for processing the surface of a lithium foil and a battery foil for a solid-state battery.

### BACKGROUND

Lithium foils or lithium metal foils as well as copper foils coated with lithium are promising for use in battery systems, in particular solid-state batteries, due to their excellent electrochemical properties. In these cases, the lithium serves as the anode material. Lithium is an alkali metal that is highly reactive. The storage and use of lithium is therefore particularly challenging. Incorrectly treated or stored lithium foils lead to deteriorating performance and lower battery capacities.

U.S. Pat. No. 6,951,120 B2 discloses the processing of crystalline lithium niobates by means of a laser. The laser has a laser beam with a wavelength close to the absorption edge of lithium niobates. The laser beam is emitted in pulses of short duration and with a repetition rate that is selected such that the surface of the lithium niobate is removed without damaging the base material. The laser beam and the substrate can be displaced against one another in order to create a trench with the desired geometry in the lithium niobate.

### SUMMARY

In an embodiment, the present disclosure provides a method for processing a surface of a lithium foil, the method comprising using a pulsed laser beam source to reduce an ion resistance of the lithium foil. The laser beam source is configured to remove lithium compounds formed on the lithium foil and introduce a structure into the surface of the lithium foil.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a flow diagram for a method according to the present disclosure;

FIG. 2 illustrates a laser processing of a contaminated lithium foil; and

FIG. 3 illustrates an ablated and structured lithium foil.

### DETAILED DESCRIPTION

In an embodiment, the present disclosure provides for reproducing the electrochemical properties of a lithium foil which has been exposed to an improper atmosphere, in particular water, oxygen and/or nitrogen.

The foregoing is achieved by a method according to the present disclosure. The method provides for the processing of the surface of a lithium foil using a pulsed laser beam source, wherein the surface processing reduces the ion resistance of the lithium foil. The laser beam source is designed to remove lithium compounds formed on the lithium foil and introduce a structure into the surface of the lithium foil.

Studies have shown that improper storage of lithium foils can lead to an increase in impedance and ion resistance, as lithium compounds are deposited on the surface of the lithium foil.

On the one hand, the method is used to clean the surface of the lithium foil by removing the lithium compounds. This leads to a reduction in ion resistance. It is surprising that the lithium compounds can be removed with a pulsed laser beam source. On the other hand, the method is used to structure the surface of the lithium foil. This leads to a further reduction in ion resistance due to the larger surface area so that, surprisingly, a lower ion resistance can be attained with the reproduced lithium foil than with an untreated and properly handled lithium foil. Consequently, when the processed lithium foil is used in a battery, increased battery performance and capacity can be achieved. The method is also particularly efficient, as removal and structuring can be carried out simultaneously.

For the purposes of the present disclosure, a “lithium foil” is to be understood as a flat material containing lithium. The flat material can further have a carrier material, such as a copper foil. Accordingly, a copper foil coated with lithium is also to be regarded as a lithium foil.

According to an embodiment, a pulse energy of the laser beam source is in a range of between 4 μJ and 6 mJ, in particular is less than 50 μJ or greater than 250 μJ. It is advantageous if the pulse rate of the laser beam source is greater than 10 kHz. It is also advantageous if the beam diameter of the laser beam source on the surface of the lithium foil is in a range of between 25 μm and 600 μm. This is accompanied by the advantage that the ion resistance of the lithium foil is further reduced. Accordingly, the use of the processed lithium foil in a solid-state battery, for example, results in increased battery capacity and performance.

It is advantageous if a lithium foil that has previously undergone a reaction that increases the ion resistance, in particular a reaction with water, oxygen and/or nitrogen, is provided in the method for processing the surface. This occurs, for example, if the lithium foil is stored improperly or if leakage occurs. As a result, a plurality of lithium compounds, in particular lithium oxide, lithium nitrides, lithium hydroxides and lithium carbonates, have formed in the lithium foil. Providing such a lithium foil is particularly well suited for the use of the laser beam source with the aforementioned parameters so that a significant reduction in ion resistance can be expected.

It is advantageous if the laser beam source introduces a structure into the surface of the lithium foil with a structure depth of at least 10% and/or of at least 2.5 μm and/or of at most 30% and/or of at most 10 μm, in particular at most 5 μm, compared to the non-structured regions of the surface of the lithium foil. This is accompanied by a further reduction in ion resistance.

It is also advantageous if the laser beam source is designed such that it has a pulse shape with a peak pulse power which is at least 10% higher than an average pulse power of the laser beam source. This is accompanied by a defined structural formation of the structure introduced into the surfaces.

Preferably, the laser beam source is designed as an ultrashort pulse laser, in particular as an ns laser, ps laser or fs laser. This achieves high intensities at moderate average power levels, ensuring targeted heat input on the surface. The laser beam source can be designed as an NIR laser.

According to an embodiment, the laser beam source has a beam quality M² in a range of between 1 and 5 and/or wherein the laser beam source is designed as a single-mode laser or as a multi-mode laser. This ensures targeted melting and/or vaporization of the surface of the lithium foil.

It is advantageous if the surface processing, in particular the laser processing, is carried out in a dry room atmosphere. This ensures a reduction in the reaction of the lithium foil with water in the ambient air.

It is also advantageous if the dry room atmosphere is adjusted such that a dew point of no more than −15° is present.

According to an advantageous further development, a beam deflection unit, in particular an optical scanner unit, is used for beam guidance of the laser beam source during the surface processing. This ensures high speed during laser processing.

It is advantageous if multiple laser beam sources and/or multiple optical units are used simultaneously. This allows the scan fields to be superimposed in order to guarantee the contour size to be achieved. This is also accompanied by higher productivity.

Preferably, the position and/or the circumferential geometry of the lithium foil is detected during the surface processing, in particular laser processing. An optical sensor system, in particular a camera system and/or optical coherence tomography (VisonLine), can be used for this purpose. As a result, tolerances in the lithium foil can be compensated for, resulting in greater precision and fewer rejects.

It is also advantageous if the processing position of the laser beam source, in particular the beam deflection unit, is adjusted on the basis of the position and/or the circumferential geometry of the lithium foil. Consequently, automated path programming can be provided for.

Advantageously, during the surface processing, in particular laser processing, the surface, in particular the surface roughness, and/or the cut position of the lithium foil is detected. A distance sensor and/or optical coherence tomography and/or laser triangulation can be used for this purpose. The cut position can be controlled by means of the surface and/or the cut position so that a higher contour accuracy can be ensured.

According to an embodiment of the present disclosure, a lithium foil is at least partially continuously processed by the laser beam source, in particular the beam deflection unit, following the position of the lithium foil. The relative movement of the lithium foil and the laser beam source can be compensated for by means of a control unit. Accordingly, a lithium foil can be unrolled from a roll and the lithium foil can be processed at the same time. This means consistent processing results and a high contour accuracy can be achieved.

Advantages of the present disclosure are also achieved by a battery foil having the features of an embodiment of the present disclosure. Accordingly, the battery foil is produced from a lithium foil processed using a method as disclosed herein. The battery foil is therefore a foil that has been structured and cleaned of lithium compounds on the surface.

Further details and advantageous embodiments of the present disclosure can be found in the following description, on the basis of which exemplary embodiments of the present disclosure are further described and explained.

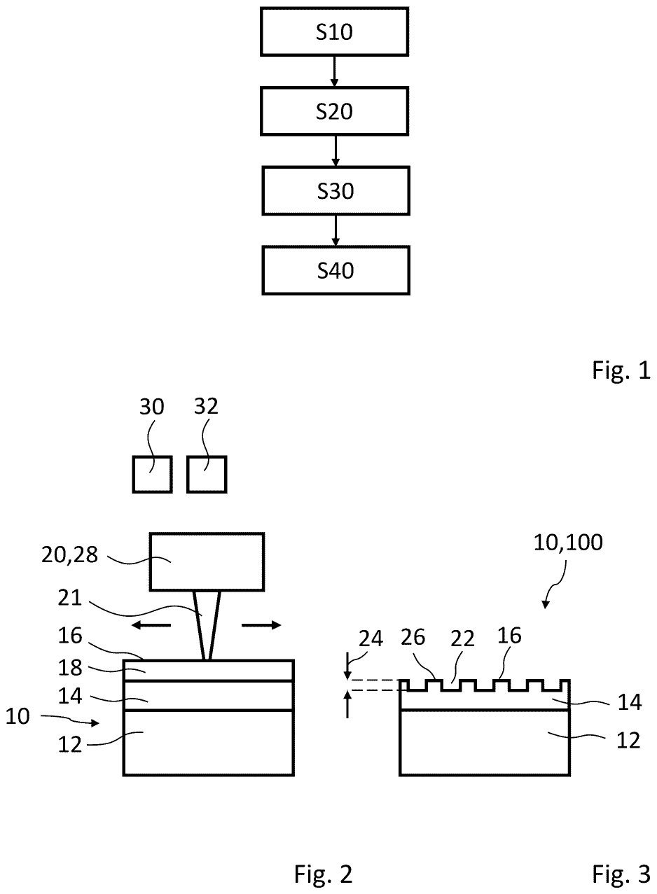

According to FIG. 1, in the method for surface processing a clean lithium foil 10 is first provided which has a carrier layer 12 made of copper and a lithium layer 14 arranged on the carrier layer 12 (S10).

Subsequently, the lithium foil 10 becomes contaminated, e.g. due to improper storage and contact with ambient air (S20). In the process, according to FIG. 2, lithium compounds 18, in particular lithium oxide, lithium nitrides, lithium hydroxides and lithium carbonates, are formed on a surface 16 of the lithium foil 10, in particular on the lithium layer 14, which increases the ion resistance of the lithium foil 10. As a result, the excellent electrochemical properties of the lithium foil 10 are lost. Accordingly, such a contaminated lithium foil 10 results in poorer battery capacity and performance.

In order to reproduce the electrochemical properties of the lithium foil 10, it is processed with a laser beam 21 using a pulsed laser beam source 20. First, a dry atmosphere with a dew point of no more than −15° is provided (S30).

The ion resistance of the lithium foil 10 is then reduced by providing the laser beam source 20 in such a way that lithium compounds 14 formed on the lithium foil 10, in particular on the lithium layer 14, are removed and a structure 22 is introduced into the surface 16 of the lithium foil 10 (S40). According to FIG. 3, the structure 22 introduced into the surface 16 of the lithium foil 10 has a structure depth 24 of at least 10% and/or of 2.5 μm compared to the non-structured regions 26. The lithium foil 10 shown in FIG. 3 can be used as a battery foil 100 with excellent electrochemical properties for a solid-state battery, for example.

In this context, the laser beam source 20 has a pulse energy in a range of between 4 μJ and 6 mJ, a pulse rate greater than 10 kHz and a beam diameter on the lithium foil 10, in particular on the lithium compounds 14 and/or on the lithium layer 14, in a range of between 25 μm and 600 μm.

The laser beam source 20 is designed such that it has a pulse shape with a peak pulse power which is at least 10% higher than an average pulse power of the laser beam source 20.

The laser beam source 20 is designed as an ultrashort pulse laser, in particular as an ns laser, ps laser or fs laser.

The laser beam source 20 has a beam quality M² in a range of between 1 and 5. The laser beam source 20 is designed as a single-mode laser or as a multi-mode laser.

For beam guidance, the laser beam source 20 has a beam deflection unit 28, in particular an optical scanner unit.

Furthermore, a sensor device 30 is provided, which is designed to detect the position and/or the circumferential geometry and/or the surface 16, in particular the surface roughness, and/or the cut position of the lithium foil 10 during the surface processing.

In addition, a control device 32 is provided which controls the parameters and/or the position of the laser beam source 20 and/or the position of the lithium foil 10, in particular on the basis of the sensor data provided by the sensor device 30.

In order to increase the surface roughness, the hatch of the laser beam 21 can preferably be reduced. The hatch can preferably be in a range of between 0.006 mm and 0.2 mm. In this regard, pulse rates of 200 kHz and 360 kHz can be selected.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for processing a surface of a lithium foil, the method comprising:
using a pulsed laser beam source to reduce an ion resistance of the lithium foil,
wherein the laser beam source is configured to remove lithium compounds formed on the lithium foil and introduce a structure into the surface of the lithium foil.

2. The method according to claim 1, wherein a pulse energy of the laser beam source is in a range of between 4 μJ and 6 mJ, and/or
wherein a pulse rate of the laser beam source is greater than 10 kHz, and/or
wherein a beam diameter of the laser beam source on the lithium foil is in a range of between 25 μm and 600 μm.

3. The method according to claim 1, wherein the laser beam source introduces the structure with a structure depth of at least 10% and/or of 2.5 μm into the surface of the lithium foil.

4. The method according to claim 1, wherein the laser beam source is configured to have a pulse shape with a peak pulse power which is at least 10% higher than an average pulse power of the laser beam source.

5. The method according to claim 1, wherein the laser beam source is configured as an ns laser, a ps laser or as an fs laser.

6. The method according to claim 1, wherein the laser beam source has a beam quality M² in a range of between 1 and 5 and/or wherein the laser beam source is configured as a single-mode laser or as a multi-mode laser.

7. The method according to claim 1, wherein the method is carried out in a dry room atmosphere.

8. The method according to claim 7, wherein the dry room atmosphere has a dew point of at most −15° C.

9. The method according to claim 1, wherein an optical scanner is used for beam guidance of the laser beam source during surface processing.

10. The method according to claim 1, wherein multiple laser beam sources and/or multiple optical units are used simultaneously.

11. The method according to claim 1, comprising detecting a position and/or a circumferential geometry of the lithium foil during surface processing.

12. The method according to claim 11, wherein a processing position of the laser beam source is adjusted based on the position and/or the circumferential geometry of the lithium foil.

13. The method according to claim 1, wherein the surface and/or a cut position of the lithium foil is detected during surface processing.

14. The method according to claim 1, wherein the lithium foil is at least partially continuously processed by the laser beam source following a position of the lithium foil.

15. A battery foil for a battery system, wherein the battery foil is produced from the lithium foil processed using the method according to claim 1.
